(19) United States
(12) Patent Application Publication
(10) Pub. No.: US 2008/0198221 A1
(43) Pub. Date: Aug. 21, 2008

(54) Satellite-receiver equipped video monitoring device

(76) Inventor: Chii-Moon Liou, Taipei Hsien (TW)

Correspondence Address: LIOU, CHII-MOON, 235 Chung-Ho Box 8-24, Taipei, omitted

(21) Appl. No.: 11/708,088

(22) Filed: Feb. 20, 2007

(51) Int. Cl. H04N 7/18; H04N 5/14; H04N 7/00

(52) U.S. Cl. 348/61; 342/55; 348/113; 348/725; 348/E05.062; 348/E07.085

(57) ABSTRACT

A satellite-receiver equipped video monitor primarily comprises a housing, a signal output device, a satellite receiver module and a video camera module, which implements the satellite receiver module to acquire satellite signals and utilizes a software tool to integrate received real-time coordinate and position information with the real-time monitoring images, so as to associate the images captured from the monitoring video with the relevant real-time time and position information. Hence, the disclosed subject matter can be applied to record the movement of a mobile object. That is, the disclosed subject matter can be installed in moving conveyances such as cars, airplanes, ships and so on for recording various circumstances that the conveyances encounters. Alternatively, the disclosed subject matter may be equipped to a human or an animal for precisely recording monitoring images thereof at particular time points.

### BACKGROUND OF THE INVENTION

1. Field of the Invention

The present invention relates to satellite receivers, and in particular to a satellite-receiver equipped video monitoring device, which achieves an integrated application of a satellite receiver module and a video camera module so as to provide monitor images stamped with real-time geographic information, such as date, time, longitude, latitude, altitude, moving speed, as well as direction and so on, which is acquired by the satellite receiver module.

2. Description of the Prior Art

Conventionally, a video monitoring system of either a fixed type or a mobile type is merely capable of providing video with real-time time and date stamp in virtue of an embedded timepiece, and is unable to provide accurate and continuously updating geographic information as those provided by a satellite receiver.

Besides, to cater to specific demand as required by regional navigation, a conventional in-car GPS navigation device may come with local mapping information only, and this consequently limits the feasibility of using such conventional GPS navigation device in other regional areas. Also, such conventional GPS navigation device is unable to associate images captured from the monitoring video shot along a route with the relevant real-time time and position information.

### SUMMARY OF THE INVENTION

The present invention relates to a satellite-receiver equipped video monitoring device, which implements a satellite receiver module to acquire satellite signals and utilizes a software tool to integrate the received signals containing coordinate and position information with the real-time monitoring images so as to facilitate analyses or identification of the monitoring images.

To achieve above object, the present invention provides a satellite-receiver equipped video monitoring device, comprising: a housing including a CPU (central processing unit) circuitry which is combined with a signal output unit, a satellite receiver module, and a video camera module; wherein the satellite receiver module comprises a satellite receiver and has functions for receiving real-time geographic information that can be integrated with a monitoring image by implementing a software tool; the video camera module being deposited on the housing for acquiring monitoring images and saving the images as image data; and the signal output unit is coupled with the CPU circuitry, and has functions for transmitting the integrated monitoring images and information produced by the satellite receiver module and video camera module to a display unit.

### BRIEF DESCRIPTION OF DRAWINGS

The invention as well as a preferred mode of use, further objectives and advantages thereof, will be best understood by reference to the following detailed description of an illustrative embodiment when read in conjunction with the accompanying drawings, wherein:

FIG. 1 is an exploded view of the disclosed satellite-receiver equipped video monitoring device according to one embodiment of the present invention;

FIG. 2 is an applied view of the disclosed satellite-receiver equipped video monitoring device showing the same assembled to a in-car mounting bracket, wherein the disclosed subject matter can be pivoted about the pivot shaft and positioned at a desired angle for shooting monitoring video;

FIG. 3 is an assembly view of the satellite-receiver equipped video monitoring device showing the disclosed subject matter to be inserted into the socket provided on the in-car mounting bracket;

FIG. 4 is a schematic drawing illustrating the application of the disclosed satellite-receiver equipped video monitoring device;

FIG. 5 is a functional diagram of the satellite-receiver equipped video monitoring device according to one embodiment of the present invention; and

FIG. 6 is a schematic drawing describing the display of the monitoring video stamped with real-time information according to one embodiment of the present invention.

### DETAILED DESCRIPTION OF THE PREFERRED EMBODIMENT

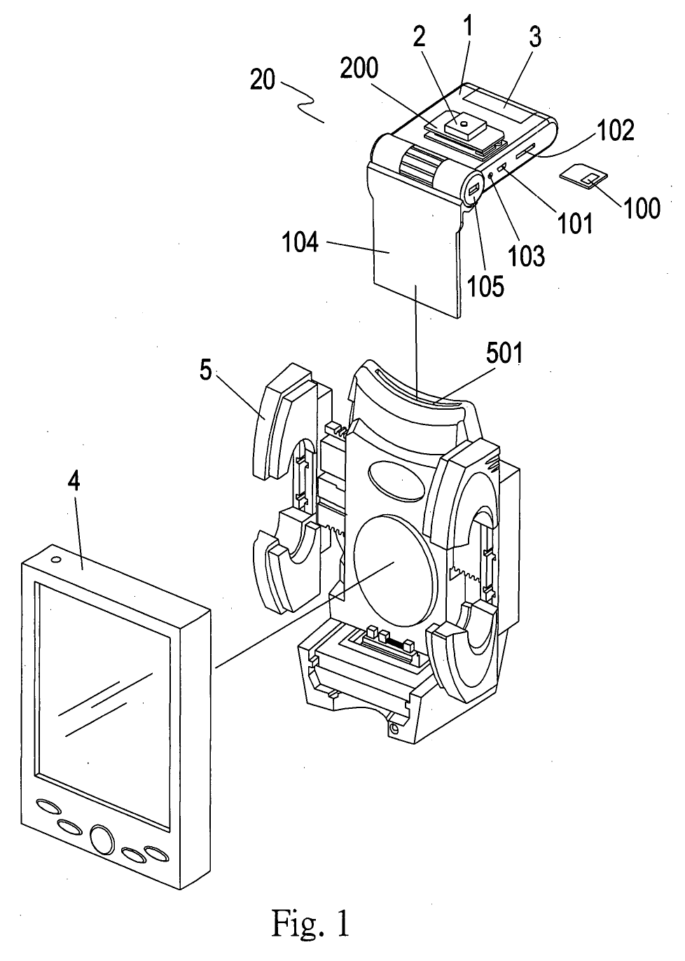

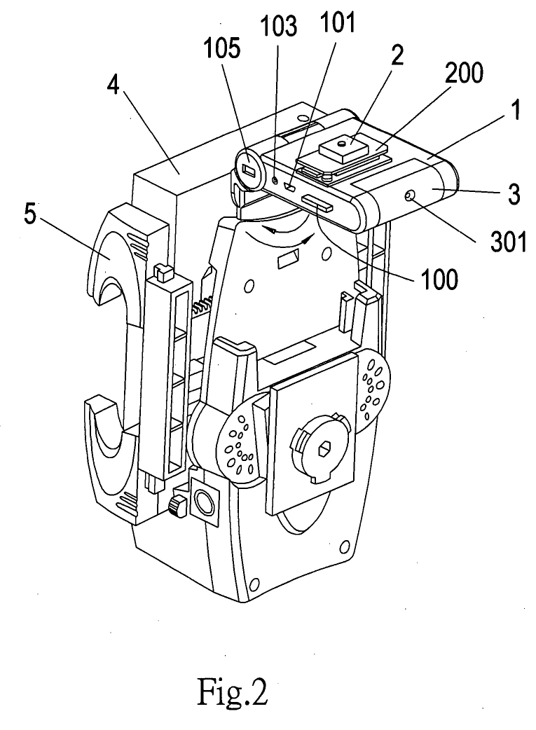

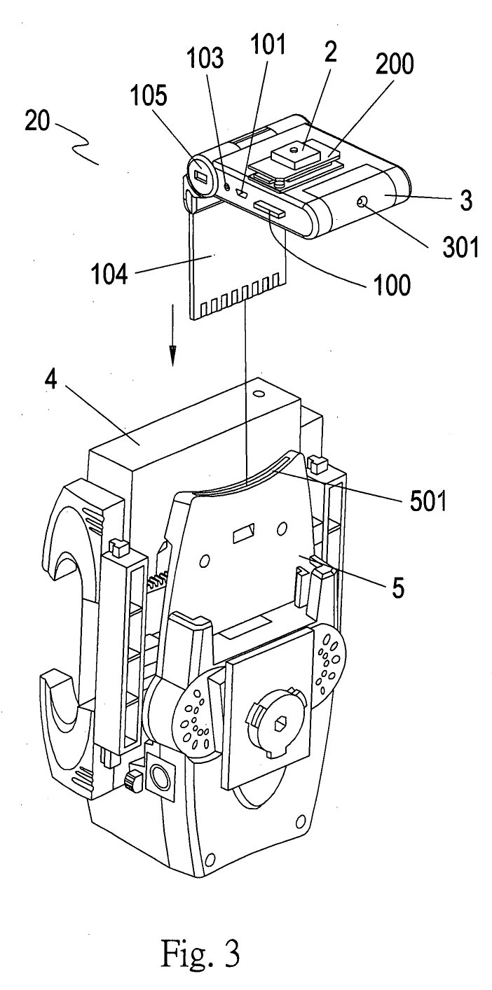

Referring to FIGS. 1 through 3, a satellite-receiver equipped video monitoring device 20 according to the present invention is illustrated. The monitoring device comprises a housing 1, a signal output unit 101, a satellite receiver module 2 and a video camera module 3.

The housing 1 has a recess for accommodating the video camera module 3 that includes a camera lens 301; has the satellite receiver module 2 deposited at a top surface thereof; and has at least one slot 102 provided at one side thereof adjacent to the top surface for receiving a storage unit 100. The storage unit 100 is communicable with a CPU (central processing unit) circuitry 200 so as to store every record of the images and information acquired from the satellite receiver module 2 and the video camera module 3 into the storage unit 100.

Moreover, the housing 1 comprises a first opening where the signal output unit 101 is allowed to output signals thereform. The signal output unit 101 is coupled with the CPU circuitry 200 and functions for transmitting the integrated images and information acquired form the satellite receiver module 2 and the video camera module 3 to a display unit 4 for presentation. The housing 1 also comprises a second opening and the CPU circuitry 200 comprises a charging circuitry and a charge jack 103. The charge jack 103 can be exposed out via the second opening. The charging circuitry is coupled with a rechargeable lithium battery (not shown); whereby the rechargeable lithium battery can be charged by being connected to an external charger.

Furthermore, the satellite-receiver equipped video monitoring device 20 of the present invention comprises a tongue 104 for being fittingly inserted into a socket 501 provided on a in-car mounting bracket 5. The tongue 104 is electrically communicated with the CPU circuitry 200 and supplies power to the CPU circuitry 200. The satellite-receiver equipped video monitoring device 20 may be further combined with the display unit 4 (such as PDA) through the in-car mounting bracket 5. As a pivot shaft 105 is provided to join the tongue 104 and the satellite-receiver equipped video monitoring device 20 together, after the satellite-receiver equipped video monitoring device 20 is assembled with the in-car mounting bracket 5 by inserting the tongue 104 into the socket 501, the satellite receiver 20 can be pivoted about the pivot shaft 105 and positioned at a desired angle for shooting monitoring video.

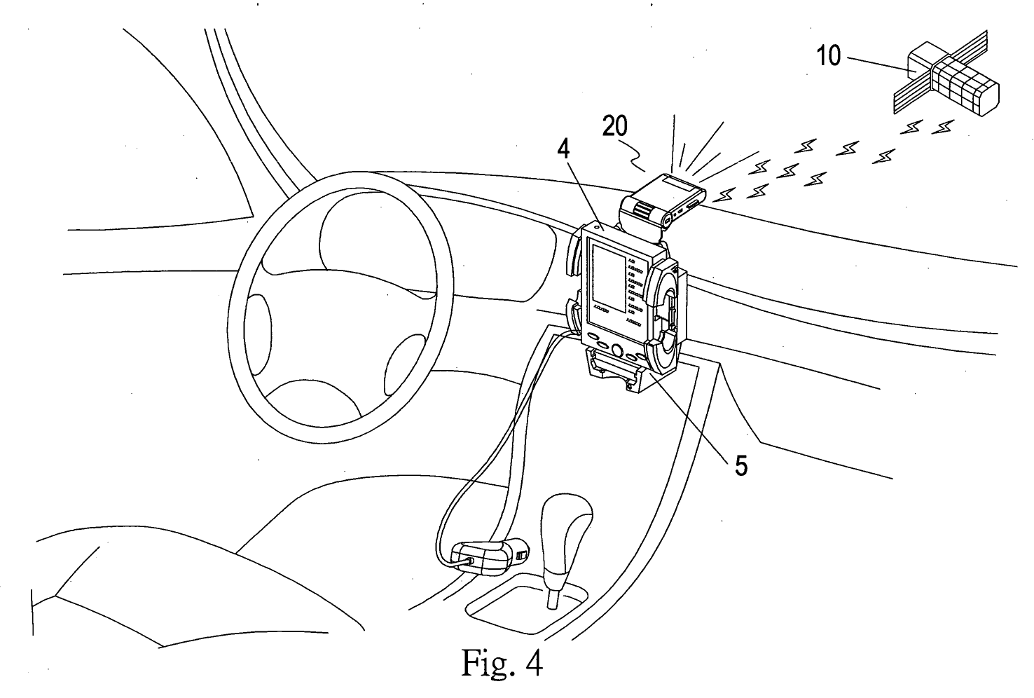

Referring to FIG. 4 for a schematic drawing illustrating the application of the disclosed satellite-receiver equipped video monitoring device 20. The in-car mounting bracket 5 is communicated with a power source, which supplies power to the display unit 4 and the satellite-receiver equipped video monitoring device 20. Therefore, the satellite-receiver equipped video monitoring device 20 can receive signals from a satellite 10 to produce real-time coordinate and position information and integrate the information with the real-time monitoring images by implementing a software tool.

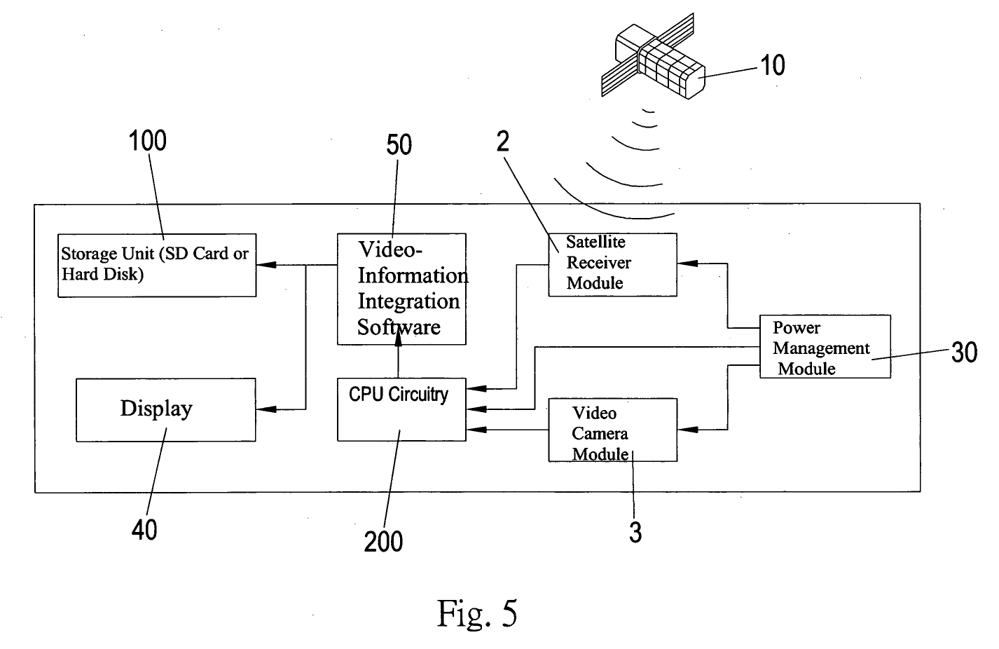

In FIG. 5, a functional diagram of the disclosed subject matter is provided. It can be seen that a power management module 30 is electrically communicated with the CPU circuitry 200 to supply power to the satellite receiver module 2 and the video camera module 3. Also, by the application of the video-information integration software 50, every record of images and information acquired by the satellite receiver module 2 and the video camera module 3 can be stored in the storage unit 100, which may be a SD card, a CF card, a SM card, a MS card, a M-MC card, an XD card or a hard disk, and the integrated images and information from the satellite receiver module 2 and the video camera module 3 can be further transmitted via video-information integration software 50 to the display unit 4 for presentation.

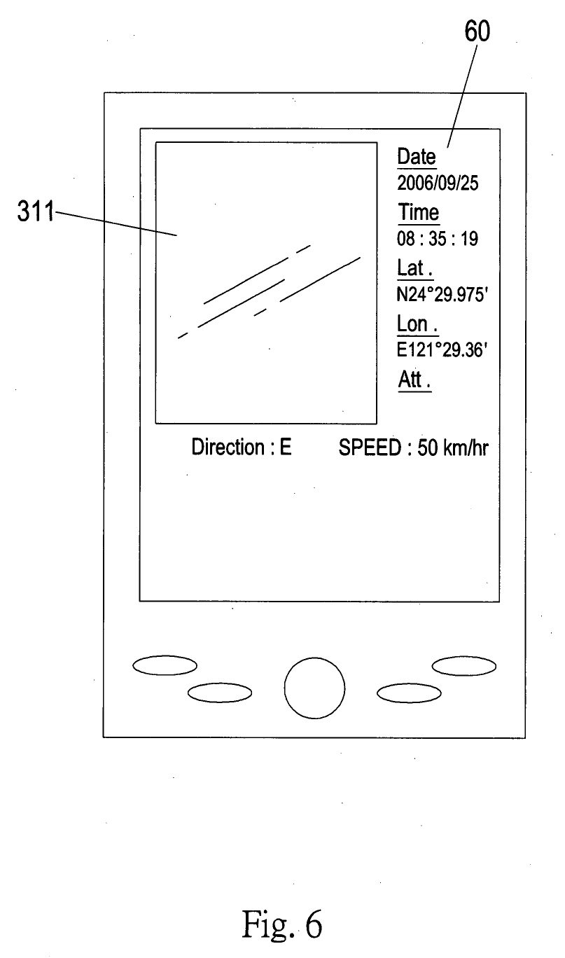

FIG. 6 is a schematic drawing describing the display of the monitoring video stamped with real-time information according to one embodiment of the present invention. A liquid crystal display 60 of a PDA is now presenting the monitoring image 311 produced by the video camera module 3 with the integrated real-time geographic information acquired by the satellite receiver module 2, such as date, time, longitude, latitude, altitude, moving speed, as well as direction and so on, that are processed by the video-information integration software.

Although a particular embodiment of the invention has been described in details for purposes of illustration, it will be understood by one of ordinary skill in the art that numerous variations will be possible to the disclosed embodiments without going outside the scope of the invention as disclosed in the claims.

What is claimed is:

1. A satellite-receiver equipped video monitoring device, comprising:
a housing including a CPU (central processing unit) circuitry which is combined with a signal output unit, a satellite receiver module, and a video camera module;
wherein the satellite receiver module comprises a satellite receiver and has functions for receiving real-time geographic information that can be integrated with a monitoring image by implementing a software tool;
the video camera module being deposited on the housing for acquiring monitoring images and saving the images as image data; and
the signal output unit is coupled with the CPU circuitry, and has functions for transmitting the integrated monitoring images and information produced by the satellite receiver module and video camera module to a display unit.

2. The satellite-receiver equipped video monitoring device of claim 1, wherein the housing has a recess for accommodating the video camera module.

3. The satellite-receiver equipped video monitoring device of claim 1, further comprising a slot, which is coupled to the CPU circuitry for storing recording data of the images and information acquired from the satellite receiver module and the video camera module into a storage unit; the recording data.

4. The satellite-receiver equipped video monitoring device of claim 1, wherein the recoding data includes at least one of date, time, longitude, latitude, altitude, moving speed, and direction.

5. The satellite-receiver equipped video monitoring device of claim 1, wherein the storage unit is selected from a group consisting of a SD card, a CF card, a SM card, a MS card, a M-MC card, an XD card and a hard disk.

6. The satellite-receiver equipped video monitoring device of claim 1, wherein the housing further comprises a first opening so that the signal output unit can be connected with the display unit.

7. The satellite-receiver equipped video monitoring device of claim 1, wherein the satellite receiver module further comprises the display unit.

8. The satellite-receiver equipped video monitoring device of claim 5, wherein the display unit further includes a mounting bracket where the display can be settled and fixed.

9. The satellite-receiver equipped video monitoring device of claim 7, wherein the mounting bracket comprises a socket that is electrically communicated with the CPU circuitry, which provides power and transmits the integrated images and information to the display unit.

10. The satellite-receiver equipped video monitoring device of claim 1, wherein the housing further comprises a second opening, and a charging circuitry; and a charge jack are further included inside of the housing, wherein the charge jack can be exposed out via the second opening, and the charging circuitry is coupled with a rechargeable lithium battery whereby the rechargeable lithium battery can be charged by being connected to an external charger.

11. The satellite-receiver equipped video monitoring device of claim 7, wherein the satellite-receiver is combined with the display unit through an in-car mounting bracket, and a pivot shaft is provided to combine the satellite-receiver-equipped video monitoring device and the in-car mounting bracket so that the satellite receiver is pivotly moveable about the pivot shaft and positioned at a predetermined angle for shooting monitoring video.

12. The satellite-receiver equipped video monitoring device of claim 10, wherein the display unit is a personal digital assistant (PDA).
